(19) United States
(12) Patent Application Publication
(10) Pub. No.: US 2006/0051723 A1
(43) Pub. Date: Mar. 9, 2006

(54) Direct bridge

(76) Inventor: Christopher John Morris, Brampton (CA)

Correspondence Address: Dr. Christopher Morris, 55 Kennedy Rd. N, Brampton, ON, L6V 1X6, CA

(21) Appl. No.: 10/936,563

(22) Filed: Sep. 9, 2004

(51) Int. Cl. A61C 13/12

(52) U.S. Cl. 433/180

(57) ABSTRACT

The invention includes new techniques, materials, and methods to build a bridge placed directly in the mouth of the patient without the laboratory making the bridge.

### BACKGROUND OF THE INVENTION

If a single tooth, or sometimes two adjacent teeth are lost, and there are healthy teeth on either side of the space created by the lost teeth, then a fixed dental prosthesis called a bridge can be used to replace the one or two teeth by fixing the prosthesis to the healthy teeth and placing a span containing replacement teeth between the healthy teeth.

Bridges can be indirect or direct bridges. The dentist himself makes a direct bridge right in the mouth of the patient.

An indirect bridge is fabricated in a laboratory on a model of the patient's teeth. Once the indirect bridge is made in the laboratory, it is sent back to the dental office where the dentist cements it in place in the patient's mouth.

In order to understand a bridge and the terminology in this application the reader should review Diagrams 1a to 1d and review the terminology definition in the descriptions of the Figures.

My invention is an invention of method, techniques, tools, and materials to produce a bridge directly in the mouth.

### DISCUSSION

### Prior Art

In the past and present, dentists have relied on porcelain bonded to metal (PBM) bridges to replace missing teeth. The porcelain bonded to metal bridge has a metal core framework that reinforces the bridge from one abutment tooth to another abutment tooth, and thus it is very strong.

To make a PBM bridge the teeth are cut and prepared and an impression is taken of the teeth and a model made of the teeth from the impression. This model is then sent to the laboratory where the laboratory constructs and makes the bridge and then sends it back to the dentist, and he then cements the bridge into the patient's mouth. Thus a PBM bridge is a laboratory processed indirect bridge.

The Directly-Placed Bridges

Dentists have for many years been experimenting and trying to develop bridges that are placed directly in the mouth. A direct-placement or direct bridge is a bridge that is built directly on the abutment teeth in the mouth of the patient The objective of placing a bridge directly in the mouth is to save chair time and to cost the patient less money and also to cut less of the abutment tooth away when making the bridge.

There have been many attempts to invent a direct bridge that dentists will be happy to use for their patients. For example, the following are patents of direct bridges where the bridge uses a metal reinforcement structure, spanning from one abutment tooth to another abutment tooth:

| | | | | | |
|---|---|---|---|---|---|
| 4,431,417 | September 1982 | 4,380,435 | April 1983 | 4,457,714 | July 1984 |
| 4,661,067 | April 1987 | 5,007,836 | May 1988 | 4,820,157 | April 1989 |
| 4,950,162 | August 1990 | 5,194,001 | March 1993 | | |

The disadvantages of the above claims are that although metal is strong, it does not bond well to dental filling materials and dental bonding resins. Also, metal is dark in color and needs to be covered with an opaque material for aesthetics.

An improvement over these patents would be the use of a material that is very strong but bonds to dental resins and is not dark in color. My invention introduces a new reinforcing material that can be used for direct bridges that has these qualities and therefore improves upon the above patents which all use metal reinforcing structures.

Due to the disadvantages of metal, dentists experimented with fibers to reinforce the dental resins in order to make reinforcement structures for direct bridges. As a result of this research, three major related patents described the use of fiber-reinforced resins.

As a result of these patents, 3 products became available for dentists to use for their patients. These products are Ribbond, by Dr. Rudo, Glasspan by Dr. Sharft, and Fibercore by Dr.s Goldberg and Burstone—licensed to Jeneric Pentron.

The instructions for use for the dentist from the Ribbond Company included cutting cavity preparations in abutment teeth and then taking the Ribbond braided fiber ribbon and adding to their ribbon a dental resin and then adding successive layers of ribbon soaked in their resin on top of each other, and placing this structure in the cavities cut in the abutment teeth and curing the structure to form a spanning reinforcement between the abutment teeth. The instructions then described adding composite resin filling material to the reinforcement and then cutting and shaping the resin into the form of a pontic.

The company Jeneric Pentron also describes the same technique using their product Fibercore in U.S. Pat. No. 6,039,569 issued on March 2000 in paragraphs 2 and 3, column 5, and further describe their technique in claims 24 to 31. Although this U.S. Pat. No. 6,039,569 describes their technique as being easy, it is not easy to perform in the mouth as it is dark, difficult to see, as the lips, cheek and tongue are in the way, and saliva is continuously egressing onto the abutment teeth wetting and contaminating the surfaces of the abutment cavities and the reinforcement as it is being assembled and the pontic as it is being built.

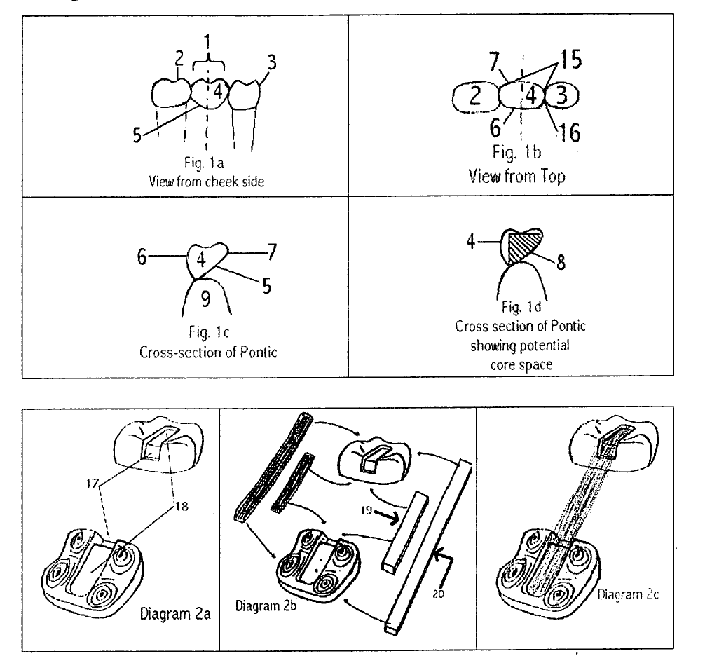

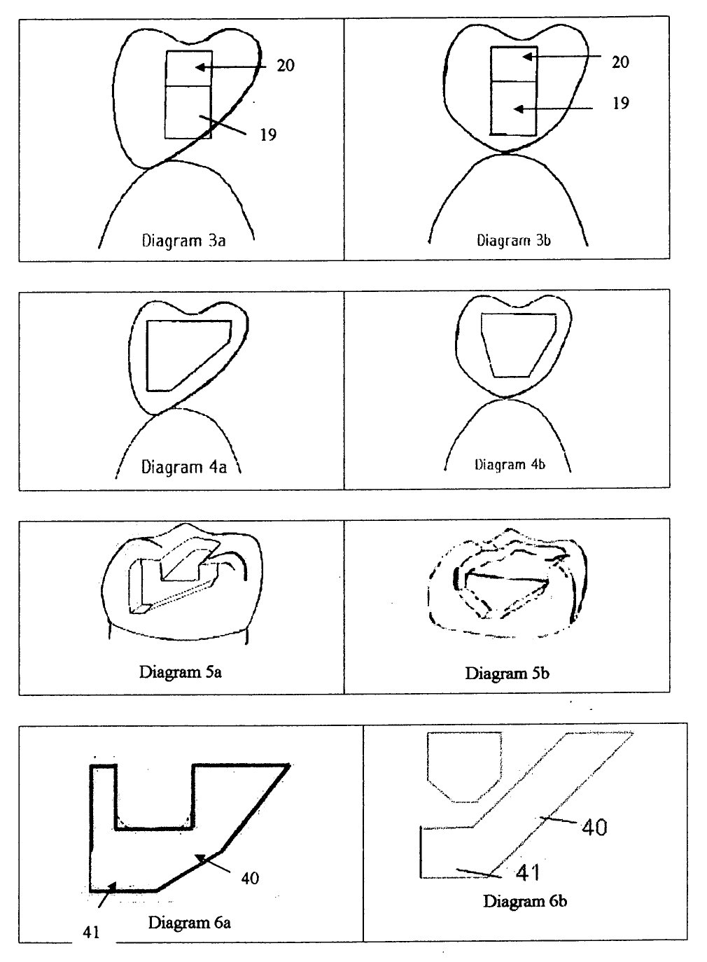

To help alleviate some of the assembly process in the mouth and thus make it easier for the dentist, patent applications have also suggested the formation of preformed bars as described in U.S. Pat. No. 4,894,012, column 8, line 66, and in U.S. Pat. No. 6,039,569, column 5, paragraph 1 (bar 12), and also in U.S. Pat. No. 6,200,136, column 4, last paragraph, and in U.S. Pat. No. 6,345,984 (bar 2), column 7, lines 27-35 and seen in the FIGS. 1a-d of that application.

Manufacturing and providing for the dentist preformed bars that he used to make himself does save time and increases the strength of the direct bridges. But then all of the patent applications describe adding layers of dental composite filling material to the reinforcement to build up material on the reinforcing bars to create a pontic.

The pontic on the reinforcing bar is slowly built up in thickness by adding and curing more and more layers of composite resin and then carving and shaping the resulting build-up into the shape of a pontic tooth. This is difficult and time consuming.

This technique of building up the reinforcement bars or structures with resin and then carving and shaping the pontic is described in the following patent applications:

U.S. Pat. No. 5,772,438 Jun. 30, 1998—see abstract

U.S. Pat. No. 6,039,569 Mar. 21, 2000, column 6, lines 14-17, claim 31

U.S. Pat. No. 6,200,136 B1 Mar. 13, 2001 column 2, line 65, column 5, lines 19-38, column 7, lines 24, and claims 5, 11 and 12

U.S. Pat. No. 6,299,499 Oct. 9, 2001—see abstract and claims

U.S. Pat. No. 6,345,984 B2 Feb. 12, 2002, claims 7, 16 and 20

U.S. Pat. No. 5,362,250 Mar. 26, 2002, column 3, lines 38-39

US2002/0082316A1 Jun. 27, 2002, paragraph 0062 and claims 16 and 17

This same process as discussed in the above patent applications of layering and building up the pontic and shaping it by hand is described in the article A Modified Technique for Direct, Fiber-Reinforced, Resin-Bonded Bridges; Clinical Case Reports by Dr. Paul van Wijlen, Journal Canadian Dental Association V.166 No 7, August 2000 and also described in Dental Products Report magazine, March 2002 in the article Constructing Upper and Lower Fiber-Reinforced Bridges Using Everstitch Reinforcement Fibers.

To summarize, the prior art of creating a bridge directly in the mouth is a lot of work for the dentist where he must create his own reinforcement and create his own pontic form. The effort required to create this pontic is significant because while he is working, blood and saliva are constantly egressing onto the teeth that he is trying to keep dry as he works. So placement of the direct placement bridge is a very difficult battle, not only to create the pontic but to keep the teeth dry while the work is being accomplished.

The next reason that direct bridges are not being used by dentists very often is that they are presently not very strong and therefore are not relied upon by dentists to provide bridges where the dentist believes that there will be any reasonably strong biting forces being applied to the direct bridge.

Direct bridges are not taught in dental schools and there have been no actual studies as to how to make direct bridges strong. In other words, to my knowledge no one has actually studied the issue of how to provide a strong direct bridge directly in the mouth, and therefore there are no protocols or guidelines established for dentists so that they know how to create a strong direct placement bridge. In addition there are no tools or materials available to assist the dentist in making a direct bridge.

There are primarily two objectives of my invention. One is to study how to make the reinforcement of a direct bridge very strong. The second objective is to make building the direct bridge easy and simple for the dentist.

Solving the Problems of the Prior Art

In my invention I have attempted to carefully study the principles of direct bridge placement and have determined that to make the strongest direct bridge one must use as much as possible of the cross-sectional area or core space of the pontic for spanning reinforcement. In order to maximize the use of the area through the pontic as reinforcement I have invented a specific shape of a cavity cut in the abutment teeth. A cavity cut in an abutment tooth is called a tooth preparation in the abutment teeth.

As well, I have invented reinforcement bars that fit these special tooth cavities or preparations to maximize the use of the core space within the pontic spanning from abutment tooth to abutment tooth. Also, I have invented techniques where these tooth preparations and reinforcement bars can be placed on the teeth quickly and easily, speeding up the process and thus making it easier for the dentist to keep the tooth dry, thus making it much simpler for the dentist My invention is especially helpful in the dentist's efforts to avoid having blood and saliva contact the teeth while he is placing the reinforcement structures, etc.

Also, I propose that the direct placement bridge be made using preformed reinforcement bars from Zirconia or Alumina or a combination of these ceramics. These materials are used in industrial applications requiring toughness and strength. They are also used to make prosthetic hips and are therefore biocompatible. In addition, in experiments I have discovered that Zirconia and Alumina bond strongly to dental materials and therefore would be perfectly suited for use as a direct bridge reinforcement. In addition, Zirconia and Alumina bars can be made in different shades of white. Therefore, I believe that a major improvement over the prior art would be to use preformed reinforcement bars of zirconia or Alumina or a combination of both where the bars would be in any size or shape to fit the particular bridge design.

My Invention

My invention has the following objectives:
1. To make the direct bridge very strong to resist high occlusal forces.
2. To make the procedure of placing the bridge very simple, quick, and easy.
3. To improve the appearance of the end result.
4. To decrease the time the patient sits in the chair and therefore decreases the cost to the patient.
5. To design a strong bridge for posterior teeth.
6. To protect the proximal gingival abutment surface from decay using a dental material wedge to cover this surface.
7. To design the tools needed to help the dentist to make this new bridge.
   My Invention Objective #1: Increasing and Maximizing the Strength of the Bridge

To maximize the strength of a bridge one has to build the thickest reinforcement possible, spanning from one abutment tooth to the other abutment tooth. In order to do this, one needs to use the maximum cross-sectional area within the pontic as spanning reinforcement. Diagrams 2a to 2c show the current art of direct bridge tooth preparation and reinforcements.

In the current art dentists build a pontic on the reinforcement shown in Diagram 2. Dentists attempt to create a pontic that has a smooth undersurface, which is close to the gum tissue that can be cleaned with dental floss. There are two designs for this type of a pontic. Cross sections of the two pontic forms used in dentistry are shown in Diagrams 3a and 3b. The position and the size of the stricture of the reinforcement within the pontic of the current art is shown as the box diagrams within the cross section diagrams of 3a and 3b.

Diagram 3a shows the current art of a proximal (19) and occlusal reinforcement bar (20) passing through a hygienic pontic where the gingival lingual corner of the reinforcement interferes with the gingival surface of the pontic.

Diagram 3b shows a proximal (19) and an occlusal reinforcement (20) of the current art passing though the alternative hygienic pontic design.

Description of Diagrams 3a and 3b

Diagrams 3a and 3b show the prefabricated reinforcement bars placed in the middle of the abutment tooth spanning though a cross section of two types of hygienic pontics. Notice that in Diagram 3a the lower corner of the proximal reinforcement bar (19) interferes with the desired cleansable convex surface of the pontic and would make placement of a preformed, prefabricated gingival veneer impossible. Also in Diagram 3a and 3b there is at least 50% of the available cross sectional area of the pontic still available for a reinforcement core to extend through the pontic.

Inadequate use of the pontic core space in the current art first of all makes the bridge weaker than it should be because the core space of the pontic is not filled with spanning reinforcement material. Secondly, the large amount of available core space in the pontic forces the dentist to spend time to build up the buccal and lingual aspects of the pontic with successive laminates of composite resin materials, which is time-consuming and is difficult in an oral environment

To make the reinforcement core as strong as possible it is the objective of this invention to make reinforcements assume as much of the cross section within the pontic as possible.

Diagrams 4a and 4b show the preferred cross section of the reinforcements running through the two possible hygienic pontic designs, which maximize the use of the pontic core space for reinforcement material.

To maximize the use of the core space requires the following inventions:

Strength Invention #1: New Cavity Design

In order to use the entire cross sectional area of the pontic as spanning reinforcement, one has to create a new proximal tooth cavity preparation in the proximal surfaces of the abutment teeth, which follows the approximate cross-sectional shape of the pontic. This proximal preparation extends as far bucco-lingually as possible to direct the forces of occlusion around the center of rotation of the abutment tooth.

The proximal tooth preparation for a direct placement bridge where the preparations mimics the cross section of the pontic of two types of hygienic pontic designs are shown in Diagrams 5a and 5b. In Diagram 5a the proximal preparation is extended as far buccally as possible to just within the embrasure space then the preparation extends gingivally to near the gingiva and then extends lingually along the gingiva to the point where the pontic lifts away from the gingiva. The cut along the gingival will usually create a flat horizontal gingival seat commonly 1-3 mm in width. At the point where the gingival surface of the pontic lifts away from the gingiva to extend occluso-lingually, the preparation follows the outline of the pontic extending diagonally from the lingual aspect of the gingival seat occluso-lingually to preferably as far as the lingual proximal line angle of the tooth.

The occlusal preparation in Diagram 5a extends along middle occlusal fissure of the tooth, past the central axis of the tooth to the marginal ridge most distant from the pontic.

Diagram 5b shows a proximal cavity preparation that assumes the same shape as the alternative hygienic pontic that is sometimes used for posterior pontics to replace molars and bicuspids shown in 4b. This pontic design (4b) touches the gingiva in the middle of the ridge and then extends occluso-buccally and occluso-lingually. Therefore the corresponding cavity preparation has its maxiumum height in the middle commonly creating a gingival seat 1-3 mm in width and then extends occluso-buccally and lingually to just within the embrasure space buccally and lingually. The occlusal preparation in 5b shows an occlusal preparation that extends up the cusp inclines, which may be done for increased strength.

Diagram 5a and 5b show potential proximal and occlusal preparations as described in my invention.

Strength Invention #2: Reinforcement Bars That Fit or Match Special Tooth Preparations

Strength invention #2 consists of reinforcement bars that are manufactured and preformed to fit into the special new tooth preparations shown in 5a and 5b and thus to fill up or maximize the use of the core space of the pontic.

Diagram 6a shows a preferred cross section of a proximal reinforcement bar assuming the cross sectional shape of the proximal preparation cut in Diagram 5a.

Diagram 6b shows another preferred cross-section of a proximal reinforcement bar (29) and an occlusal reinforcement bar (30) to be fitted to the tooth preparation seen in Diagram 5a.

Both 6a and 6b show diagrams of proximal reinforcing bars that fill the proximal preparations shown in 5a. In both 6a and 6b the unique feature to note is that the gingival aspect of the bar at one point extends occluso-lingually (40) from the gingival cut. In these two diagrams of proximal reinforcement bars there is also a gingival horizontal flat plane (41) that sits on the gingival seat of the preparation. It is not necessary to have a gingival horizontal flat plane in my invention but it is certainly preferable.

Diagram 19 shows a proximal and occlusal bar cross-section of bars designed to fit onto the preparation seen in Diagram 5b. The proximal bar has its maximum vertical height in the middle where it extends toward the gingiva and commonly has a gingival horizontal flat plane (41) 1 to 3 mm in width that sits on the gingival seat of the preparation. The preparation then extends occluso-buccally (42) and occluso-lingually (40).

Strength Invention #2a: Aggregate Reinforcement Core Assembly

In some instances large reinforcement bars that attempt to fit the tooth preparations require a lot of trimming by the dentist. A method to reduce the amount of trimming is to use numerous bars to fill the core space. In other words a simple method for the dentist to build up and fill up the core space easily with the least trimming would be an aggregate or assembled reinforcement structure where the dentist is provided with numerous different bars that can be added together to fill the reinforcement core between the abutment teeth and to fill the special tooth preparations of the abutment teeth, where to simplify a complete filling of the core space, a preferred embodiment would likely have 1 to 3 large reinforcement bars, then provide the dentist with numerous small diameter reinforcement bars, preferably 0.25 mm to 1.25 mm in diameter where these smaller bars are packed into the voids that are left within the special tooth preparations between the larger bars. This prevents the need to spend time trimming the larger bars to make them fit each other and fill the core space.

In this embodiment no time is spent trimming and fitting, the dentist simply places the larger bar or bars to fill up most of the core space and then adds tiny bars to fill in the voids and spaces remaining in the core space. This is a quick and simple way of filling the core space with reinforcing material. This would be an aggregate bar reinforcement method

Strength Invention 2b: Translucent Reinforcement Bars

The reinforcement bars have to be cemented or bonded in place between the abutment teeth. The bonding is cured commonly by light. In order to assist in the curing process of the bonding a preferred embodiment of the reinforcement bar would be if it were translucent and transmitted light so that light could reach the bonding underneath and in between the reinforcement bars to adequately cure the bonding used to bond the reinforcement bars in place. A possible method of creating translucent reinforcement may be by using glass fibers such as E-Glass or S-glass or quartz fibers, etc. These glasses can be treated with silane to assist the bonding resin to bond to the glass fibers.

Strength Invention #3: Building the Gingival Surface first to Maximize the Proximal Preparation for Strength

Another invention to create a strong bridge is facilitating the dentist's understanding of how large to cut the preparation within the tooth and also facilitating the placing of the reinforcement bars by assisting in keeping the tooth preparation dry and free of blood and saliva, therefore making the dentist's job much easier. This last invention consists of placing the gingival aspect of the bridge in place and fixing it between abutment teeth before the dentist cuts the tooth preparations in the abutment teeth. Once the dentist has the gingival aspect of the pontic bonded in place he can see the outline of the pontic and can cut the largest proximal tooth preparation that is possible for the pontic to maximize the full core space within the pontic, and can cut the preparation in the exact position on the abutment tooth to fit the pontic.

Strength Invention #4: Gingival Proximal Wedge

To improve the strength of a bridge one has to use as much surface area of the abutment tooth as is available to bond to the bridge. To increase the strength of the bridge, my invention includes adding a wedge of composite resin preferably extending below the gingiva on the proximal surface of the abutment tooth (22, Diagram 9). This wedge serves to increase the bonding area of the bridge and thus increasing the strength. It also serves to create a mechanism to which the gingival veneer is bonded in place before the preparations are cut. But most importantly, it serves to protect the proximal-gingival surface of the root of the abutment tooth from collecting bacteria underneath the bridge and thus beginning to decay, therefore protecting the long-term durability of the bridge.

Diagram 9 shows a proximal gingival wedge (22) and a preformed gingival veneer (23) and a small dab of composite resin (24) bonding the veneer to the wedge.

To create the small wedge of filling material on the proximal gingival area of the pontic I have invented a small tool or instrument that pushes the gums away at the proximal aspect of the tooth, allowing the dentist to create a wedge of dental filling material that preferably extends just below the gum tissue on both abutment teeth. The dental instrument has a thin flat plate aspect that can slip below the proximal-gingiva on an abutment tooth and can create a matrix for the dentist to place filling material on the proximal surface of the abutment tooth between the abutment tooth and the flat plate of the instrument and cure the material.

Diagram 13a to 13b shows the proximal wedge and a possible design of the proximal wedge tool. Another embodiment would be to provide the dentist with preformed composite wedges that he places on the proximal-gingival surface of the abutment teeth and bonds in place. These wedges would preferably be stiff but malleable to adapt to the tooth surface. However they could also be of a cured hard consistency and bonded in place with a layer of resin.

Invention Objective #2: To Increase Simplicity, Ease, and Efficiency of Placing the Direct Bridge in the Mouth

In the prior art the dentist had to build his own reinforcement using fibers and he had to build his own pontic. While he is doing this work, cheeks and tongue get in the way, he cannot see very well in the mouth and saliva is contaminating the teeth that he has prepared. This makes it very difficult for the dentist to provide an excellent bridge treatment. In my invention I provide the dentist with preformed bridge components that are easily assembled in the mouth.

These components are illustrated in the Diagrams 10 and 11 where the preferred illustrated components are a proximal reinforcement bar (25), an occlusal reinforcement bar (26), a gingival veneer (27), and an occlusal-buccal veneer (28).

Diagram 10—Illustrated assembly of bridge parts including proximal bar (25), occlusal bar (26), gingival veneer (27), occluso-buccal veneer (28).

Diagram 11—Illustrated assembly of the bridge parts (24), proximal bar (25), occlusal bar (26), gingival veneer (27), occluso-buccal veneer (28).

Simplicity Invention #2: Female Molds for the Dentist to make Bridge Parts

Providing preformed bridge veneers or surfaces of the pontic requires the cost of stocking numerous shapes, sizes, and shades of components. Therefore to reduce this cost, I have invented female molds of various sizes and shapes where the dentist places the dental material of the appropriate shade in the mold and cures the dental material lifts the bridge part out of the mold. This way, the dentist can pre-make his own bridge components himself before he starts to work in the mouth so that he merely needs to assemble the bridge in the mouth.

The female mold can be of any surface or combination of surfaces of the pontic including occlusal, buccal, gingival, and lingual surfaces. Diagram 12 shows a block preferably of plastic containing female molds.

Simplicity Invention #3: Bonding the Gingival Surface of the Pontic First

In the prior art dentists cut preparations in the abutment teeth and then built their bridge. This creates numerous problems for the dentist.

In my invention I provide the tools and materials for the dentist to place the gingival surface of the bridge that contacts the gums first. After the gingival veneer is bonded in place, the dentist knows exactly where to cut the tooth preparation because he cuts within the gingival, the buccal, and the lingual extent of the gingival surface of the bridge that is already bonded in place on the abutment teeth. This simplifies matters tremendously. Also, by building the undersurface of the bridge first one prevents blood and fluids from the gingival crevice around the tooth from seeping onto the tooth preparations and helps keep the preparation dry while bonding the bridge in the mouth, thus greatly simplifying the placement of this bridge, as well as improving the quality of the final product.

Diagram 9 shows the gingival veneer bonded to the abutment teeth before the teeth are prepared with cavities.

Simplicity Invention #4: Preformed Buccal-Occlusal veneers or Molds for such Veneers

Once the gingival or underside of the bridge is placed and the reinforcement has been placed on top, then all that is needed is the buccal and occlusal portions of the pontic to be added. This is preferably done using one veneer that encompasses both the occlusal and the buccal aspect of the bridge and this veneer can be made of any dental material including dental ceramics or composite resin. The veneer can be provided in a set of different shapes, sizes, and shades for the dentist. Or, to save money, the dentist may use a set of female molds that can be provided for the dentist where he simply selects the size of the occlusal-buccal veneer that he needs and then places his dental filling material of the color shade that he is using for the bridge into the mold that he selects and cures it and lifts it out and then bonds it on top of the reinforcement to complete the bridge.

This mold method is largely cost saving as providing the dentist with preformed occlusal buccal veneers of differing sizes in a variety of color shades of each size would necessitate a large inventory and significant cost.

Diagrams 14a-14c show a preferred occlusal buccal veneer.

Preferred Embodiments of the Preformed Gingival Veneers and Molds for Gingival Veneers

To build the gingival surface of the bridge, first one needs gingival veneers. These veneers are shown in Diagrams 16a-16c. Gingival veneers in one preferred embodiment are bonded to the wedges of composite on the proximal surfaces of the abutment.

Gingival Veneer Embodiment #1: Lateral Extensions

An embodiment of the preformed gingival veneer could be where the gingival veneer has mesial and distal lateral extensions, which serve to extend towards the proximal surfaces of the abutment teeth and serve to assist and provide a bonding between the abutment teeth and the gingival-lingual veneer. These veneers are shown in Diagrams 16d-16f.

Gingival Veneer Embodiment #2: Malleable Veneers

Another preferred embodiment of the veneers show in Diagrams 16a-16f would be if the veneers would be firm and not tacky, but somewhat malleable so that they can be adapted to the ridge form of the patient This veneer could also be provided to the dentist in the form of a sheet of dental material preferably about 0.5 to 1.0 mm thick, or when the sheet is “cookie” cut to create small, flat pieces in the shapes of veneers. These veneers could then be pressed onto the wedges and the edentulous ridge and cured in place to form the gingival pontic veneer surface.

Gingival Veneer Mold Embodiment #3: Mold with Lateral Extensions

Another embodiment for the gingival veneer would be where the dentist is provided with molds where the dentist can make his own veneers by curing filling material in a mold. The molds can be in the shape shown in 16a-c, the shape shown in 16d-f with extensions or the mold can be in a block with other molds as seen in Diagram 12. The gingival molds may have a female depression to the lateral aspect in the mesial and distal sides of mold. Such a mold could then be used to make preformed gingival veneers with lateral extensions. The lateral extensions are used to bond the veneer to the abutment proximal surfaces or to the wedges of composite on the proximal surfaces of the abutment teeth.

The molds shown in Diagram 16d-f have lateral extensions where these molds can be applied and positioned directly in place on the gingiva and where composite resin or dental filling material can be placed in the mold and in the lateral extensions and where the mold, filled with dental filling material, can be cured and bonded in place on the gingiva after which the thin plastic mold can be removed.

Individual thin transparent molds can also be used to place on the bridge to form the occluso-buccal surfaces.

Illustrations of the gingival veneer or molds are seen in Diagram 16.

### DESCRIPTIONS OF DRAWINGS

Diagram 16:

a. Cross-section gingival veneer or veneer mold. (side view)
b. Above view gingival veneer or veneer mold.
c. Cross-section gingival veneer or veneer mold (front view) from the anterior area of the mouth.
d. Cross-section gingival veneer or veneer mold with extensions (side view).
e. Above view gingival veneer or veneer mold with extensions.
f. Front view gingival veneer or veneer mold with extensions.

Diagram 17 shows my new method, materials, and instruments for my new direct bridge construction.

Working in the mouth is difficult My technique, method, materials, and instruments facilitate and speeds the process of placing a bridge directly in the mouth. This sequence of diagrams 17a-17k shows a preferred method of this invention of direct bridge construction.

Diagram 17a shows two abutment teeth.

Diagram 17b shows two proximal wedge instruments oriented towards the abutment teeth to create the wedge.

Diagram 17c shows the abutment teeth with the proximal wedges on the abutment teeth created with the instrument. These proximal wedges can also be created using preformed malleable composite resin wedges that are bonded onto the proximal surfaces of the abutment teeth.

Diagram 17d shows a gingival-lingual prefabricated veneer with lateral extensions. The veneer is preferably malleable and can be adapted to the ridge of the patient and as in this preferred embodiment the lateral extensions are bonded to the wedges.

Diagram 17e shows the gingival lingual veneer placed on top of the proximal wedges and bonded. Diagram 17e also shows composite resin laid between the abutment tooth and the lingual aspect of the veneer completing both the gingival and lingual surfaces of the pontic as demonstrated by horizontal lines. Diagram 17e also shows the outline of the preparation into the abutment teeth that is then cut by the dentist by the dotted line in the abutment teeth.

Diagram 17f shows proximal reinforcement bars cut to length, ready to place between the proximal preparations of abutment teeth. These proximal bars may be made of Zirconium, Aluminum or fiber-reinforced composite resin.

Diagram 17g shows the proximal reinforcement bars placed and bonded between the abutment teeth.

Diagram 17h shows the occlusal reinforcement bar, which may be fabric-stripped or a malleable reinforcement bar such as Glasspan, Ribbond, Fibercore, or could be made of Zirconium, etc.

Diagram 17i shows the pontic veneer where the veneer is preferably a combination of the occlusal and buccal surfaces.

Diagram 17k shows the occluso-buccal veneer bonded in place to complete the bridge.

Diagram 18:

Diagram 18a-18i also show a preferred method of bridge construction as described in this invention.

18a shows an above view and later cross-section of the gingival veneer.

18b shows a wedge of dental material on the proximal gingival surface of the abutment tooth.

18c shows an instrument designed to create the proximal gingival wedge.

18d shows the gingival veneer bonded in place on the gingival wedges.

18e also shows the gingival veneer bonded in place on the wedges and where the abutment teeth have not yet been cut and prepared.

18f shows a blackened area on the proximal surface of the abutment tooth where the dentist can clearly see that he would have to cut and prepare the tooth in order to maximize the volume of reinforcement that passes through the pontic.

The blackened area in 18g shows where the dentist may add dental filling materials to strengthen the bond of the veneer before cutting the abutment teeth.

18h shows the tooth preparations cut in the abutment teeth.

18i shows the reinforcement placed and bonded on top of the gingival veneer. All that is needed now is for the occluso-buccal veneer to be added on top of 18i.

Alternative Proximal Reinforcement Bars

Proximal reinforcement bars do not have to have a gingival surface that follow the outline of the gingiva of the pontic but rather can be devoid of a gingival surface. These proximal bars are seen in Diagrams 20a and 20b. The diagram shows a cross-section of a proximal reinforcement bar for a bridge that has a horizontal plate portion (44) 0.5 mm to 4 mm thick extending from the buccal embrasure to the lingual aspect of an abutment tooth where the horizontal plate has a vertical extension, (45) extending towards the gingiva of the abutment tooth where the vertical extension is 0.5 mm to 4 mm in width where the horizontal plate sits on a horizontal preparation cut along the marginal ridge of the proximal surface of the abutment tooth, and where the vertical extension fits into a vertical preparation cut in the proximal surface of the abutment tooth and where in the pontic area between the abutment teeth the horizontal plate may extend in width to be the width of the pontic tooth.

Combined Proximal and Occlusal Universal Reinforcement Bar

It is possible to combine the proximal and occlusal reinforcement bars into one solid structure where this structure can be made of any dental restorative material. This universal bar would need to be trimmed to fit the proximal and occlusal preparations of the tooth. Cross-sections of my preferred embodiments of a universal reinforcement bar are seen in Diagram 21a and 21b. The diagram shows a universal reinforcement bar for a dental bridge that has a horizontal plate portion (46) that is 0.5 mm to 4 mm thick that extends from buccal embrasure to the lingual aspect of the abutment tooth, and also has a gingival vertical extension (47) that extends towards the gingiva where the vertical extension is 0.5 mm to 4 mm wide and where the horizontal plate has the vertical extensions (48) in the middle area of the horizontal table that extends in the occlusal direction that is 0.5 mm to 4 mm wide and this bar is used in that the horizontal plate is trimmed to sit on a horizontal proximal preparation cut in the proximal surface along the marginal ridge of the abutment tooth, and where the gingival vertical extension is trimmed to fit in the vertical cut in the proximal surface of the abutment tooth and where the occlusal extension is cut and trimmed to fit in preparations cut in the midline occlusal fissure.

Cantilever Bridge

A design for a reinforcement structure for a cantilever bridge is shown in Diagrams 22a to 22d. This reinforcement structure can be manufactured from any dental restorative material, including all metals, ceramics, and composites, and fiber-reinforced composites.

Diagram 22a shows a lateral view of a cantilever reinforcement Diagram 22b shows the cantilever reinforcement on two abutment teeth and where the cantilever portion extends out to the left to support a pontic. Diagram 22c shows the above view of a preferred embodiment of the cantilever reinforcement. 22d shows an end-on view of the reinforcement.

My universal cantilever reinforcement is preferably one solid structure consisting of a flat table portion (49) supporting the occlusal surface of the pontic where the table is just slightly less than the width of the pontic and extending from the middle of the table is an occlusal extension (50) which is bonded into occlusal fissure preparations cut in the abutment teeth and under the table there is a vertical portion (51) starting from under the table which is bonded into the proximal preparation of the abutment tooth and rests on the seat of the proximal preparation.

The occlusal extensions can have indentations and enlargements in the occlusal extension portion where the indentations/enlargements are intended to provide a dovetail effect to assist to lock in the occlusal extension into the occlusal fissure preparation.

The cantilever reinforcement is designed to fit into a tooth preparation that has a horizontal marginal ridge (52) preparation preferably cut 2 mm below the marginal ridge extending from just inside the buccal embrasure to the lingual aspect of the tooth and a preparation cut from the middle of the occlusal fissure (53) and a vertical preparation cut (54) from the horizontal marginal ridge down toward the gingival where it finishes with a flat gingival seat.

Laboratory Processed Bridge—Embodiments of the Invention

The effort so far has been to try to find a way to reinforce a direct bridge that is placed directly in the mouth without assistance from a laboratory. However, the same principles that have been used in my direct bridge placement can also be used for a laboratory-processed bridge. An embodiment of my invention for the laboratory-processed bridge would be to use the reinforcement structures of Zirconia or Alumina or a combination of both for a laboratory processed bridge.

Examples of the laboratory-processed bridge can be seen in Diagrams 24a-24d.

Diagram 24a shows a pontic with a rectangular zirconia bar through the middle of the pontic and the proximal ends of zirconia bar cemented into a cavity preparation in the mesial distal of the abutment teeth. Possible cross sections of this bar can be seen in 24c and 24d; however numerous cross-section designs to aid in retention of the pontic could be manufactured.

Diagram 24b shows either two possibilities where one rectangular bar is cut into a shape so that it can fit simultaneously into the occlusal preparation and the proximal preparation of the abutment teeth and the pontic is formed on this bar or where the laboratory or the dentist uses a proximal reinforcement bar and then an occlusal reinforcement bar together and then fabricates the tooth on these bars.

Diagram 24c and 24d show potential cross sections of the zirconia bar through the formed pontic, however, a variety of designs are possible.

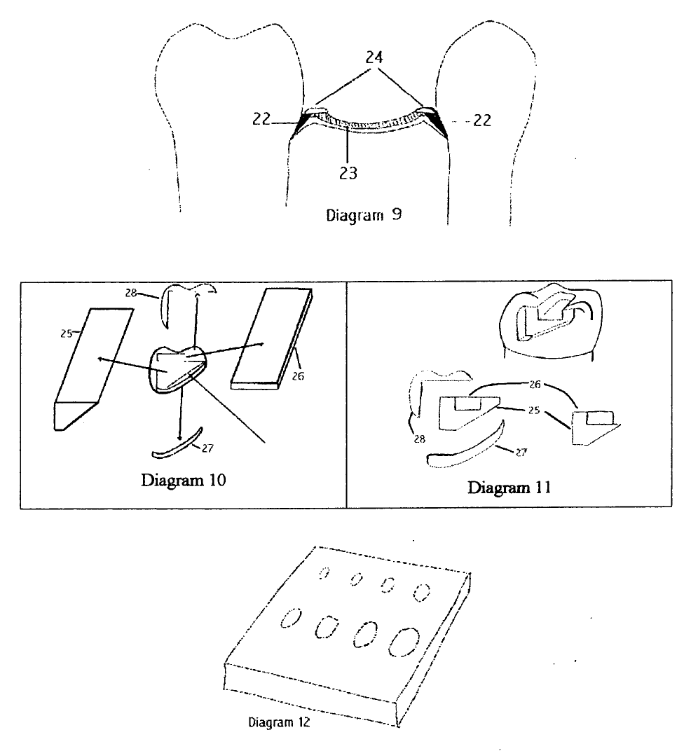

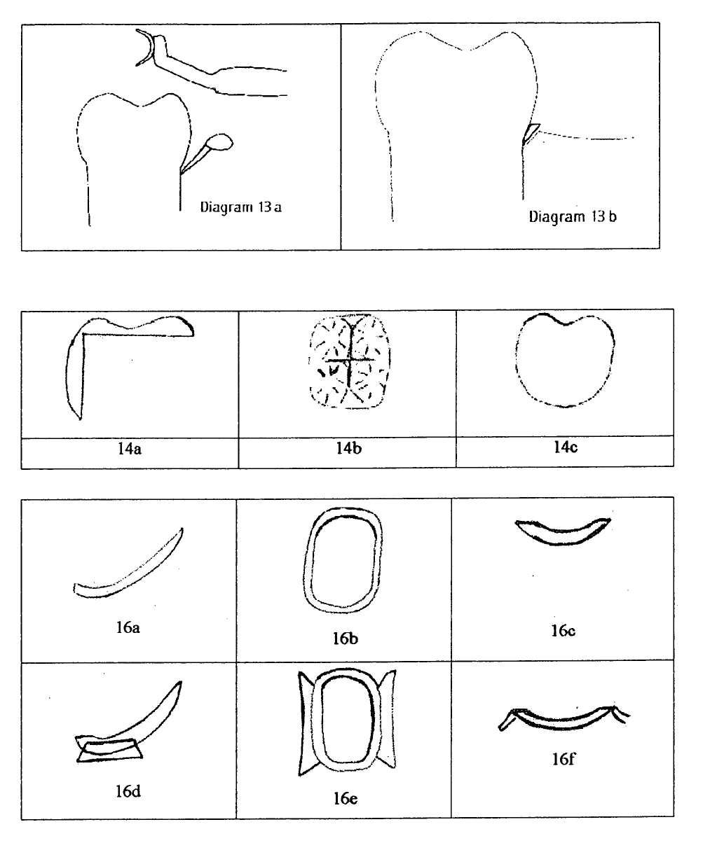

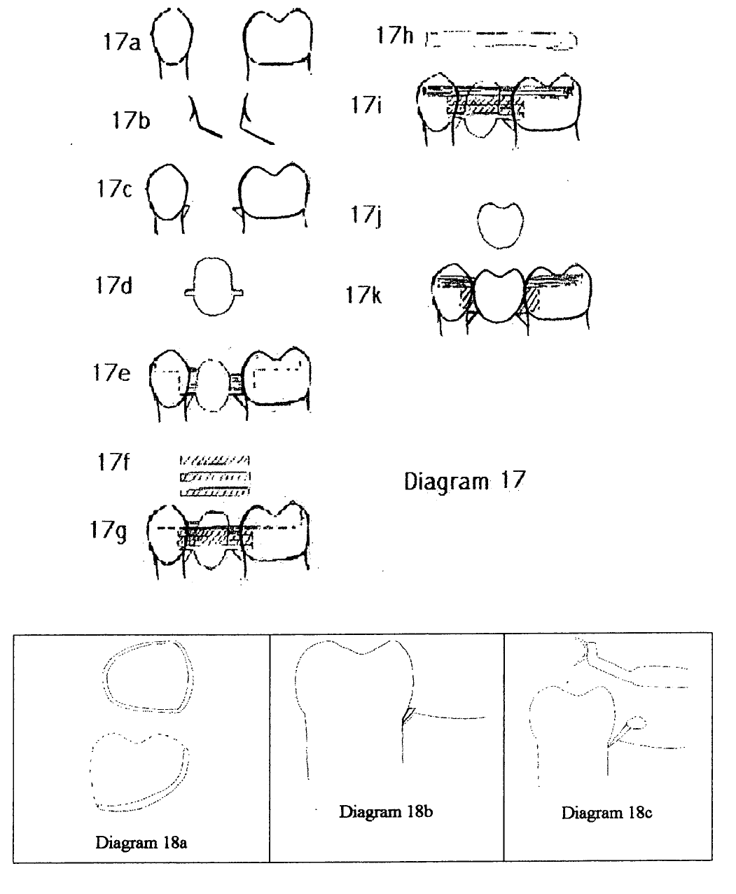

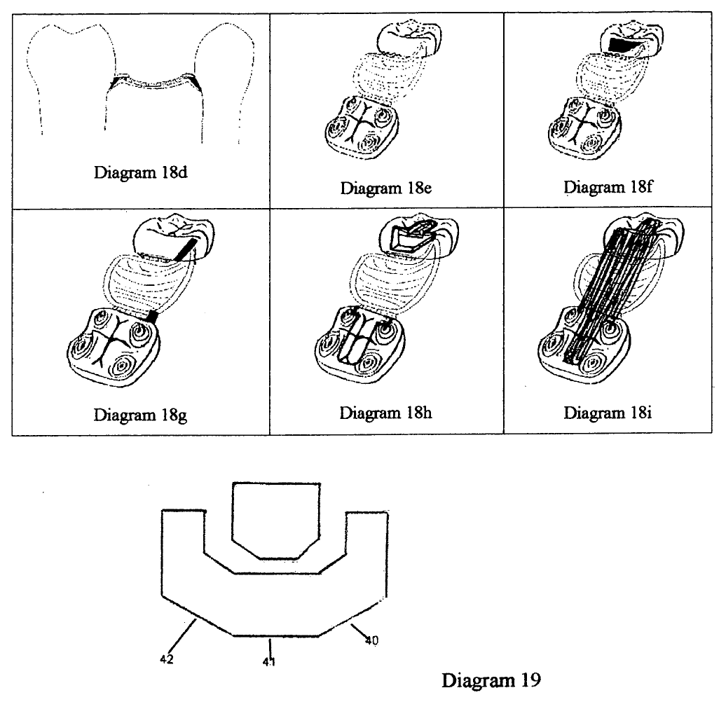

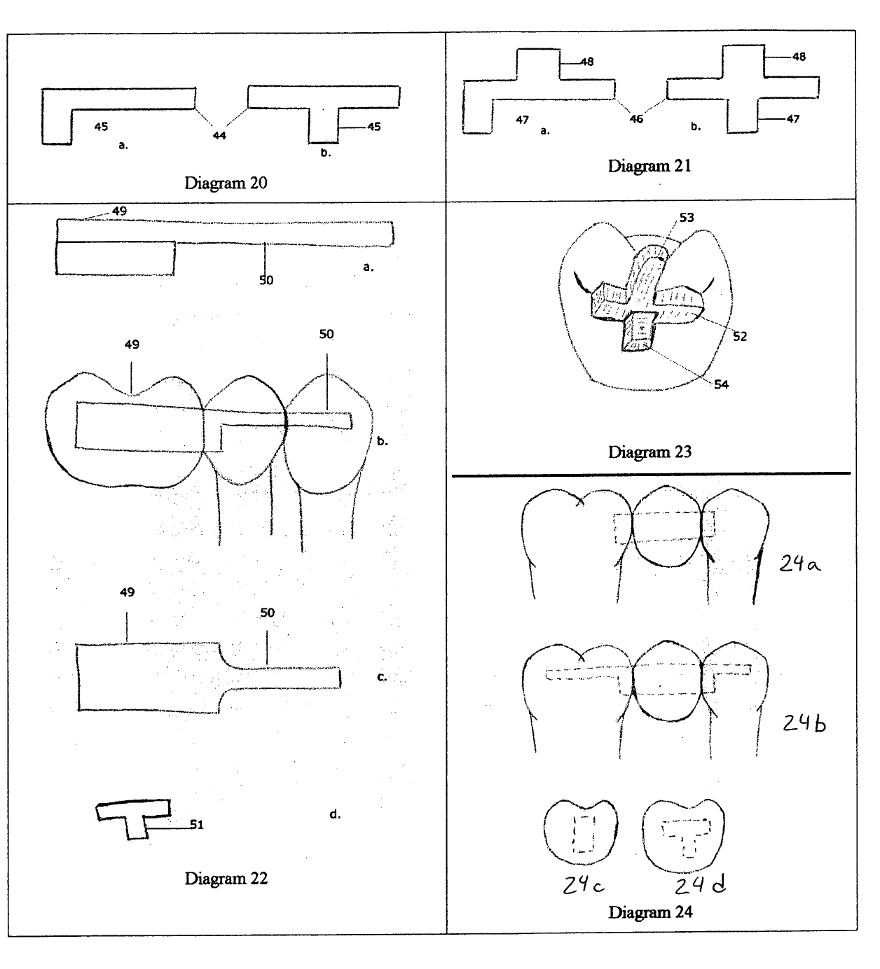

This concept for bridge construction (both direct and laboratory-processed) is not a new concept, however using reinforcement bars of zirconia, alumina, or a combination of the two is a novel concept. Reviewing previous patent applications such as U.S. Pat. No. 5,772,438, FIG. 9 and U.S. Pat. No. 4,371,005, FIG. 18 and U.S. Pat. No. 4,789,338, FIG. 3 and U.S. Pat. No. 5,007,836, as well as U.S. Pat. No. 4,950,162, one can see that the concepts of providing a reinforcement and a laboratory-processed or a direct-placement pontic, is not new.

What is new is the long sought-after perfect reinforcement, which I believe is the zirconia, alumina, or the blend of the two ceramics used in place of stainless steel or other metal.

### DIAGRAMS

### Diagram List

Diagrams 1a to 1d show a dental bridge and its parts and terminology.

Diagram 1a—View from Cheek Side i.e. buccal side
1. Edentulous space—an edentulous space is a space that is devoid of natural teeth.
2. Abutment tooth—the abutment teeth are healthy teeth that hold and support the bridge.
3. Abutment tooth.
4. Pontic—The pontic is the prosthetic tooth that replaces the missing tooth.
5. Gingival Surface—the gingival surface is the surface of any part of the bridge that is closest to the gingival. The surface that is being pointed to (#5) is the gingival surface of the pontic. The gingiva is the gum tissue.

Diagram 1b—Top view of the Bridge
2. Abutment tooth.
3. Abutment tooth.
4. Pontic.
6. Cheek side of the bridge; also called the buccal side because the cheek is formed by the buccinator muscle.
7. Tongue side or lingual side of the bridge.
15. Lingual proximal line angle is a corner of the tooth where the proximal and lingual surfaces meet. The proximal surface of any tooth is the surface closest to the adjacent tooth. Since there is a tooth on either side most teeth have two proximal surfaces, one siding with each adjacent tooth.
16. Buccal proximal line angle is a corner of the tooth where the buccal proximal surfaces meet.

The dotted line shows the point of cross-section through the pontic. This cross-section is shown in FIGS. 1c and 1d.

Diagram 1c—Cross-section of the pontic
4. The pontic.
5. The gingival surface of the pontic.
6. The cheek side or buccal side.
7. Tongue side or lingual.
9. The edentulous ridge—the edentulous ridge of bone and gum tissue that remains in the mouth after teeth are extracted. It is usually a smooth, round, horseshoe-shaped ridge. The shape differs slightly in the upper and lower jaws.

Diagram 1d—Cross-section of pontic showing potential core space for reinforcement span, which extends through the pontic and rests in the cavity's cut in each abutment tooth. It is an object of the invention to fill as much as possible of the core space of the pontic with reinforcement bar(s).
4. Cross-section of pontic.
8. Shows the core space available through the pontic.

Diagrams 2a to 2c show the current art of direct bridge tooth preparation and reinforcements.
2a. shows the current art of tooth preparation where 17 points to the proximal preparation and 18 points to the occlusal preparation.
2b. shows the current art of reinforcement made from Glasspan, Ribbond, or FiberCore where 19 is the proximal reinforcement bar and 20 is the occlusal reinforcement bar.
2c. shows the reinforcement placed from abutment tooth to abutment tooth.

Diagram 3 shows cross sections of the two pontic forms used in dentistry.
Diagram 3a shows the current art of a proximal (19) and occlusal reinforcement bar (20) passing through a hygienic pontic where the gingival lingual corner of the reinforcement interferes with the gingival surface of the pontic.
Diagram 3b shows a proximal (19) and an occlusal reinforcement (20) of the current art passing though the alternative hygienic pontic design.
   Diagrams 4a and 4b

Diagrams 4a and 4b show the preferred cross section of the reinforcements running through the two possible hygienic pontic designs, which maximize the use of the pontic core space for reinforcement material.

Diagrams 5a and 5b show two preferred cavity preparations.

Diagram 6a shows a preferred cross-section of a proximal reinforcement bar.

Diagram 6b shows a preferred cross-section of a proximal reinforcement bar (29) and an occlusal reinforcement bar (30) which positioned similarly as they would be within a pontic core.

Diagrams 7 and 8 were deleted.

Diagram 9 shows a proximal gingival wedge (22) and a preformed gingival veneer (23) and a small dab of composite resin (24) bonding the veneer to the wedge.

Diagram 10 shows bridge assembly components, a proximal reinforcement bar (25), an occlusal reinforcement bar (26), a gingival veneer (27), and an occlusal-buccal veneer (28).

Diagram 11 shows bridge assembly components, a proximal reinforcement bar (25), an occlusal reinforcement bar (26), a gingival veneer (27), and an occlusal-buccal veneer (28).

Diagram 12 shows a block of plastic containing female molds.

Diagram 13a to 13b shows the proximal wedge and a possible design of the proximal wedge tool.

Diagrams 14a-14c show a preferred occlusal buccal veneer.

Diagram 15 was deleted.

Diagrams 16a to 16f show above view, side view, and front views of gingival veneers or molds for gingival veneers.

Diagram 16:

a. Cross-section gingival veneer or veneer mold. (side view)
b. Above view gingival veneer or veneer mold.
c. Cross-section gingival veneer or veneer mold (front view) from the anterior area of the mouth.
d. Cross-section gingival veneer or veneer mold with extensions (side view).
e. Above view gingival veneer or veneer mold with extensions.
f. Front view gingival veneer or veneer mold with extensions.

Diagram 17 shows a preferred method of this invention of bridge construction.
Diagram 17a shows two abutment teeth.
Diagram 17b shows two proximal wedge instruments oriented towards the abutment teeth to create the wedge.
Diagram 17c shows the abutment teeth with the proximal wedges on the abutment teeth created with the instrument. These proximal wedges can also be created using preformed malleable composite resin wedges that are bonded onto the proximal surfaces of the abutment teeth.
Diagram 17d shows a gingival-lingual prefabricated veneer with lateral extensions. The veneer is preferably malleable and can be adapted to the ridge of the patient and as in this preferred embodiment the lateral extensions are bonded to the wedges.
Diagram 17e shows the gingival lingual veneer placed on top of the proximal wedges and bonded. Diagram 17e also shows composite resin laid between the abutment tooth and the lingual aspect of the veneer completing both the gingival and lingual surfaces of the pontic as demonstrated by horizontal lines. Diagram 17e also shows the outline of the preparation into the abutment teeth that is then cut by the dentist by the dotted line in the abutment teeth.
Diagram 17f shows proximal reinforcement bars cut to length, ready to place between the proximal preparations of abutment teeth. These proximal bars may be made of Zirconium, Aluminum or fiber-reinforced composite resin.
Diagram 17g shows the proximal reinforcement bars placed and bonded between the abutment teeth.
Diagram 17h shows the occlusal reinforcement bar, which may be fabric-stripped or a malleable reinforcement bar such as Glasspan, Ribbond, Fibercore, or could be made of Zirconium, etc.
Diagram 17i shows the pontic veneer where the veneer is preferably a combination of the occlusal and buccal surfaces.
Diagram 17k shows the occluso-buccal veneer bonded in place to complete the bridge.
   Diagram 18:

Diagram 18a-18i also show a preferred method of bridge construction as described in this invention.
18a shows an above view and later cross-section of the gingival veneer.
18b shows a wedge of dental material on the proximal gingival surface of the abutment tooth.
18c shows an instrument designed to create the proximal gingival wedge.
18d shows the gingival veneer bonded in place on the gingival wedges.
18e also shows the gingival veneer bonded in place on the wedges and where the abutment teeth have not yet been cut and prepared.
18f shows a blackened area on the proximal surface of the abutment tooth where the dentist can clearly see that he would have to cut and prepare the tooth in order to maximize the volume of reinforcement that passes through the pontic.
The blackened area in 18g shows where the dentist may add dental filling materials to strengthen the bond of the veneer before cutting the abutment teeth.
18h shows the tooth preparations cut in the abutment teeth.
18i shows the reinforcement placed and bonded on top of the gingival veneer. All that is needed now is for the occluso-buccal veneer to be added on top of 18i.

Diagram 19 shows a cross section through a proximal and occlusal reinforcement bar that are designed to fit the tooth preparation seen in Diagram 5b. The proximal bar is shown as #19 where the bar has its highest height in the midline area with a gingival seat #40 and where the gingival seat extends occluso-buccally (42) and occluso-lingually (41).

Diagram 20 shows two cross sections of proximal reinforcement bars where the horizontal table is 44 and the gingival vertical extension is 45.

Diagram 21 shows two cross sections of combined proximal and occlusal reinforcement bars where the horizontal table is 46, the gingival vertical extension is 47 and the occlusal vertical extension is 48.

Diagram 22 shows a cantilever reinforcement structure where the horizontal table is 49, the occlusal extension is 50 and the vertical extension portion is 51.

Diagram 23 shows a preparation cut in an abutment tooth designed to receive a cantilever reinforcement shown in Diagram 22 where the horizontal marginal ridge preparation is 52 the occlusal fissure preparation is 53 and the vertical preparation is 54.

Diagrams 24a and 24b show a laboratory processed bridge with reinforcement structures through the pontic and bonded into cavity preparations on the abutment teeth. 24c and 24d show possible cross-sections of the reinforcement bars in 24a and 24b.

1. I claim a direct dental bridge where the bridge is built directly on the teeth in the mouth where;
a. Cavity preparations are cut in the abutment teeth and where,
b. One or more preformed reinforcing structures bars containing Zirconium oxide or Aluminum oxide or a combination of both are bonded into place in the cavities cut in the abutment teeth spanning across an edentulous space from one abutment tooth to the other abutment tooth and where
c. The pontic of the bridge is assembled on the Zirconium and/or Aluminum oxide reinforcement structures.

2. I claim a proximal tooth preparation for a bridge where the preparation mimics the cross-section of the pontic of the said bridge where the proximal preparation is extended as far buccally as possible to just within the embrasure space then the preparation extends gingivally to near the gingiva and then extends lingually along the gingiva, commonly creating a flat horizontal gingival seat and extends horizontally along the gingiva to the point where the pontic lifts away from the gingiva in the occluso-lingual direction, the preparation then follows the outline of the pontic extending diagonally from the lingual aspect of the flat horizontal gingival seat occluso-lingually.

3. I claim a proximal reinforcement bar where a portion of the gingival surface of the bar extends diagonally in an occluso-lingual direction.

4. I claim a proximal reinforcement bar as in claim #3 where the gingival surface of the bar also has a flat horizontal gingival plane on the buccal aspect of the bar and from the lingual aspect of the horizontal flat gingival plane the gingival surface of the bar extends occluso-lingually.

5. I claim a proximal cavity preparation for a bridge where the preparation has its maximum height in the middle area of the tooth and extends gingivally and then extends from the gingiva occluso-buccally and occluso-lingually.

6. I claim a proximal cavity preparation for a bridge where the preparation has its maximum height in the middle area of the tooth and has a flat gingival seat portion in the middle of the tooth and extends from the flat gingival seat occluso-buccally and occluso-lingually.

7. I claim a proximal reinforcement bar that loosely fits the proximal tooth preparations of claims 5 and 6 where the proximal bar has gingival surfaces that extend occluso-lingually and occluso-buccally.

8. I claim a proximal reinforcement bar that loosely fits the proximal tooth preparations of claims 5 and 6 where the proximal bar has a flat horizontal gingival plane that fits the gingival seat of the preparation claimed in claim #6 and extends occluso-lingually and occluso-buccally from the flat horizontal gingival plane.

9. I claim a group of reinforcement bars that, when assembled, are designed to fit the tooth preparations that are claimed in claims 2, 5, and 6 such that one or more reinforcement bars are relatively large in cross section and where other small diameter reinforcement bars are added to fill in the voids left in the core space by the large bar(s) where the small bars are 0.25 mm to 1.25 mm in diameter.

10. I claim a dental tool that has a thin flat blade that can slip below the proximal-gingiva on an abutment tooth and can create a matrix for the dentist to place dental material on the proximal surface of the abutment tooth between the abutment tooth and the plane of the instrument, where the dental material can be held in place on the tooth and then cured and then the instrument removed, leaving a wedge of dental material on the proximal gingival surface of the abutment tooth.

11. I claim a preformed piece of dental material that can be in the shape of a wedge where the piece of dental material is bonded on the proximal-gingival aspect of an abutment tooth.

12. I claim a group of female molds for veneers of surfaces of a pontic tooth that are provided in a variety of sizes where the molds are for any surface of a pontic of a bridge or a combination of surfaces, including the occlusal, buccal, lingual, and gingival surfaces where the dentist merely needs to place within the female mold a dental restorative material and then cure this said material and then lift it out of the mold to have formed for the dentist the surface veneer of the pontic that he/she wishes to use.

13. I claim a female mold as in claim #12 where the group of female molds are in a variety of shapes and sizes and are in one block or sheet of material.

14. I claim a group of female molds for pontic surfaces that are provided individually in different sizes.

15. I claim a group of female molds for the gingival-lingual and/or gingival surfaces of the pontic where the mold contains lateral extensions, which extend mesially and distally from the gingival mold.

16. I claim a method of bridge construction where any surface of the pontic is prefabricated to be of a specific shape, color, and staining where it can be bonded to any missing surface of the pontic of the bridge, and where said prefabricated surfaces include the occlusal buccal, gingival, and lingual surfaces or any combination of these surfaces and where these are provided to the dentist in a variety of shapes and sizes, and where these prefabricated surfaces can be made of any biocompatible material.

17. I claim preformed gingival veneer of a pontic as in claim 16 where the gingival-lingual surface has mesial and distal extensions that extend towards the mesial and distal proximal surfaces of the abutment teeth.

18. I claim a gingival veneer that is firm but malleable where the gingival veneer is placed on the edentulous ridge and using its malleable nature is bent and formed to fit the shape of the ridge where the malleable veneer can be in the shape of a veneer or can be in the form of a thin sheet of dental restorative material.

19. I claim a method of bridge construction where the dentist takes an impression of the unprepared, uncut teeth and sends this impression to a supply company who then uses the impression to select the bridge parts needed to make the bridge and sends the bridge parts to the dentist for assembly directly on the teeth.

20. I claim a prefabricated direct placement bridge kit consisting of some or all of the following prefabricated parts to be assembled and bonded together directly in the mouth where the prefabricated parts include:
a. A proximal gingival wedge
b. A gingival surface veneer or a mold for such a veneer.
c. A prefabricated proximal reinforcement bar or bars.
d. A prefabricated occlusal reinforcement bar or bars.
e. A prefabricated occlusal and buccal surface veneer or separate occlusal and buccal veneers or a mold for said veneers.

21. I claim a method or system of bridge construction that includes the placement of a wedge of dental material on the proximal-gingival area of the abutment teeth.

22. I claim a method of bridge construction as in claim 21 where a preformed gingival veneer is bonded to the wedges of dental material on the proximal-gingiva area of the abutment teeth claimed in claim #21.

23. I claim a method of direct bridge construction that includes some or all of the following steps:
a. Wedges of dental material are bonded onto the proximal gingival surface of the abutment teeth.
b. A preformed veneer is bonded to the wedges.
c. The tooth preparations are cut.
d. The proximal reinforcement bar is bonded in place.
e. The occlusal reinforcement bar is bonded in place.
f. The occlusal/buccal veneer is bonded in place at the same time as the occlusal reinforcement or after it is placed.

24. I claim reinforcement bars, which are translucent and transmit light so that the bonding resin underneath or in-between the translucent reinforcement bars can be cured with light that passes through the translucent bars.

25. I claim translucent bars as in claim 25 that are made using glass fibers, such as E-Glass, S-glass, U-glass, etc. and/or quartz fibers.

26. I claim prefabricated reinforcement bars which have incorporated within their structure one or more finished external surfaces of the pontic including the occlusal, buccal, and gingival surfaces.

27. I claim a prefabricated reinforcement bar for anterior teeth where the bar has a cross sectional shape of a rectangle where the bar is 1.00 mm to 10.00 mm in height and 0.5 mm to 2.00 mm in width.

28. I claim a laboratory-processed bridge that uses reinforcement structures made of zirconia or alumina or a blend of both where these structures are used as reinforcements passing through the pontic and where the structures are bonded into cavity preparations within abutment teeth.

29. I claim a pre-fabricated reinforcement for a cantilever bridge that has a wide table portion supporting the occlusal surface of the pontic and is similar in width to the upper third of the cantilever pontic tooth where it has a long occlusal extension from the middle area of the table that extends the length of one or more adjacent abutment teeth where this extension is placed into occlusal fissure preparations cut in the adjacent abutment teeth, and where there is a vertical portion starting from underneath the table that extends towards the gingiva where the vertical portion sits in a vertical proximal preparation cut in the adjacent abutment tooth and rests on the gingival seat of the vertical proximal preparation cut in the adjacent abutment teeth.

30. I claim a proximal reinforcement bar for a bridge that has a horizontal plate portion 0.5 mm to 4 mm thick extending from the buccal embrasure to the lingual aspect of an abutment tooth, where the horizontal plate has a vertical extension, extending towards the gingiva of the abutment tooth where the vertical extension is 0.5 mm to 4 mm in width, where the horizontal plate sits on a horizontal preparation cut along the marginal ridge of the proximal surface of the abutment tooth, and where the vertical extension fits into a vertical preparation cut in the proximal surface of the abutment tooth and where in the pontic area between the abutment teeth the horizontal plate may extend in width to be the width of the pontic tooth.

31. I claim a reinforcement bar for a dental bridge that has a horizontal plate portion that is 0.5 mm to 4 mm thick that extends from buccal embrasure to the lingual aspect of the abutment tooth, and has a gingival vertical extension that extends towards the gingiva where the vertical extension is 0.5 mm to 4 mm wide and where the horizontal plate has the vertical extensions in the middle area of the horizontal table that extends in the occlusal direction that is 0.5 mm to 4 mm wide where the horizontal plate is trimmed to sit on a horizontal proximal preparation cut in the proximal surface along the marginal ridge of the abutment tooth, and where the gingival vertical extension is trimmed to fit in the vertical cut in the proximal surface of the abutment tooth and where the occlusal extension is cut and trimmed to fit in preparations cut in the midline occlusal fissure.

32. I claim reinforcement bars as in claims 3, 4, 7, 8, 9, 27, 29, 30 and 31 that are made of any dental material including zirconia or alumina ceramics, other dental ceramics or dental composite resin materials or fiber-reinforced dental materials where the fiber can be E-Glass, S-Glass, quartz fibers, carbon fibers, or polyethylene or Kevlar or any other fiber that can be used to reinforce dental materials.
